(19) United States
(12) Patent Application Publication
(10) Pub. No.: US 2025/0215801 A1
(43) Pub. Date: Jul. 3, 2025

(54) REINFORCEMENT FOR A COMPOSITE BLADE OF A TURBOMACHINE, COMPRISING A MIXTURE OF FIBER CUTS AND A TACKIFIER

(71) Applicant: SAFRAN, PARIS (FR)

(72) Inventors: Manon COMMARMOT, MOISSY-CRAMAYEL (FR); Noemie STEENBAKKER, MOISSY-CRAMAYEL (FR); Nicolas QUAGLIA, MOISSY-CRAMAYEL (FR); Nicolas DROZ, MOISSY-CRAMAYEL (FR)

(73) Assignee: SAFRAN, PARIS (FR)

(21) Appl. No.: 18/853,379

(22) PCT Filed: Mar. 30, 2023
(86) PCT No.: PCT/FR2023/050458

§ 371 Date: Oct. 1, 2024

(30) Foreign Application Priority Data
Apr. 1, 2022 (FR) FR2203001

(51) Int. Cl. F01D 5/28; F01D 5/14; F01D 25/24

(52) U.S. Cl. CPC F01D 5/282; F01D 5/147; F01D 25/24; F05D 2230/23; F05D 2300/603

(57) ABSTRACT

The present invention concerns a reinforcement for a blade of a turbomachine, the blade comprising a first outer skin and a second outer skin which are made of composite material each comprising an inner end portion spaced apart from each other in such a way as to delimit therebetween an inner cavity of the blade that opens into an opening at an inner end of the blade, the inner end being radially opposite the outer end, wherein the reinforcement is adapted to be arranged in the inner cavity in such a way as to close the opening, and wherein the reinforcement comprises a mixture of cuts of at least one fiber and a tackifier, the cuts having lengths comprised between 1 mm and 15 mm, the tackifier comprising an epoxy resin solubilized in a solvent.

### TECHNICAL FIELD

The present application relates to aircraft turbomachines, in particular turbojet engines or turboprop. The application relates to a reinforcement for a composite turbomachine blade, a composite blade provided with such a reinforcement, and a method for manufacturing such a reinforcement and such a composite blade.

### TECHNOLOGICAL BACKGROUND

An aircraft typically comprises at least one turbomachine to provide propulsion.

The turbomachine comprises at least one fan or propeller, at least one compressor, a combustion chamber, at least one turbine, and a gas exhaust nozzle. For example, the turbomachine may comprise a low-pressure compressor and a high-pressure compressor, and a high-pressure turbine and a low-pressure turbine. The high-pressure turbine rotates the high-pressure compressor via a high-pressure shaft, and the low-pressure turbine rotates the low-pressure compressor via a low-pressure shaft. The low-pressure turbine may also rotate the fan either directly via the low-pressure shaft or via a reduction gear arranged between the low-pressure turbine and the fan, the reduction gear being rotated by the low-pressure shaft.

The fan comprises a hub and blades secured to the hub, the fan blades being rotatable about a longitudinal axis of the turbomachine. A secondary flow rectifier may be arranged downstream of the fan. The rectifier comprises rectifier blades located downstream of the fan blades, the rectifier blades being stationary, that is to say being fixed in rotation relative to the longitudinal axis of rotation of the fan blades.

In a ducted turbomachine, or turbojet engine, the fan is housed in a fan casing, upstream of the rest of the turbomachine.

In an unducted turbomachine or turboprop (or Unducted fan or open rotor), the fan is an unducted propeller placed outside the nacelle, in the airflow surrounding the turbomachine. An unducted turbomachine may comprise two unducted and counter-rotating fans, or propellers (known as UDF for “Unducted Fan”), or alternatively an unducted single fan and a rectifier comprising several rectifier blades (known as USF for “Unducted Single Fan”). The fan may be placed at the rear of the gas generator so as to be of the pusher type or at the front of the gas generator so as to be of the tractor type. An unducted turbomachine allows to increase the bypass ratio very significantly without being penalized by the mass of the casings or nacelles intended to surround the fan vanes.

The turbomachine can be a dual-flow turbomachine, in which the air mass drawn in by the fan is divided into a primary flow, which passes through the at least one compressor, the combustion chamber and the at least one turbine, and a secondary flow, which is concentric with the primary flow. The bypass ratio of a turbomachine corresponds to the ratio between the primary flow rate and the secondary flow rate. Increasing the bypass ratio improves the performance of the turbomachine and reduces its specific fuel consumption. This results in an increase in the diameter of the blades at iso engine thrust, in particular the fan blades and the associated stator blades. This increase in dimensions is even more significant for unducted turbomachines, in which the blades are larger and the rotation speeds are lower. Increasing the dimensions of the blades results in an increase in the mass of the blades, in particular the stator blades, which is detrimental to the performance of the turbomachine.

In order to reduce the mass of the blades, the blades can be designed in organic matrix composite material comprising a fibrous reinforcement embedded in an organic matrix. Furthermore, the organic matrix can be partially hollow, reinforcing only the structural portions.

Known from the prior art, as illustrated in FIG. 1, is a rectifier blade 100 of a ducted turbomachine extending radially between an inner platform, by which the blade 100 is fixed to an inner casing of the turbomachine, and an outer platform, by which the blade 100 is fixed to an outer casing of the turbomachine. Each blade 100 comprises a vane body made of composite material consisting of a fiber reinforcement having a three-dimensional weave and densified by a matrix. The fiber reinforcement has an end portion comprising two segments 200 disconnected from each other up to a free end of the fiber reinforcement. The blade 100 further includes a gap filler or roving subcomponent in the form of an added insert 300 allowing to fill a free space at the junction between the segments 200 of the fiber reinforcement. The insert 300 may in particular be manufactured from a shaped braid. Document FR 3 063 514 A1 describes such a rectifier blade, the blade further comprising an added insert having a pi-shaped section. Thus, the blade may be manufactured from a solid composite material instead of metallic materials such as titanium, and the increase in the mass of the blade is reduced.

However, the insert does not meet the new geometric and structural constraints of a composite blade, in particular a 3D woven organic matrix composite blade of a secondary flow rectifier. Indeed, the evolution of the target geometry of the added insert, which must have a very significant thickness variation, makes its manufacture using known techniques, such as from a shaped braid, unfeasible.

Furthermore, in unducted turbomachines, fixing the blade, in particular the stator blade, to a casing of the turbomachine only by its inner radial end located at the blade root, has the consequence of transmitting all the forces in the blade root area, which results in high levels of stresses in the composite portions of the blade root. The known added inserts do not allow the blade root area to be sufficiently reinforced locally, and thus do not sufficiently limit the opening and the stresses at the disconnected segments of the fiber reinforcement under tensile, compressive and bending biasing. Furthermore, the known inserts manufactured from a braid have too low a rigidity and therefore do not allow the overall stiffness of the blade to be sufficiently increased, which results in an increased risk of buckling and a degradation of the frequency placement of the rectifier.

### GENERAL DISCLOSURE

A purpose of the present application is to propose a reinforcement for a composite turbomachine blade allowing to reduce the stresses exerted on the blade at a structural area of the blade, and allowing to limit the increase in the mass of the blade.

Another purpose of the application is to propose a reinforcement for a composite turbomachine blade having a complex geometry and satisfactory mechanical resistance properties.

Another purpose of the application is to propose a method for manufacturing such a reinforcement which is simple to implement and allows to quickly create a reinforcement having a complex geometry.

For this purpose, according to a first aspect, provision is made of a reinforcement for a blade of a turbomachine, the blade comprising a first outer skin and a second outer skin which are made of composite material connected to each other at an outer end of the blade, the first skin comprising a first inner end portion, the second skin comprising a second inner end portion, the first inner end portion and the second inner end portion being spaced apart from each other in such a way as to delimit therebetween an inner cavity of the blade that opens into an opening at an inner end of the blade, the inner end being radially opposite the outer end, wherein the reinforcement is adapted to be arranged in the inner cavity in such a way as to close the opening, and wherein the reinforcement is adapted to be arranged in the inner cavity so as to close the opening, and wherein the reinforcement comprises a mixture of cuts of at least one fiber and a tackifier, the cuts having lengths greater than or equal to 1 mm, the tackifier comprising an epoxy resin solubilized in a solvent.

Some preferred but non-limiting features of the reinforcement according to the first aspect are the following, taken individually or in any technically conceivable combination:
the cuts are obtained from a strip of prepreg comprising carbon fibers, preferably the strip of prepreg is recycled;
the tackifier comprises between 20% and 85% by mass of epoxy resin, preferably approximately 25% by mass of epoxy resin,
the epoxy resin is PR520 resin and the solvent is acetone;
the mixture comprises between 65% and 85% by mass of tackifier and between 15% and 35% by mass of cut fiber, preferably approximately 75% by mass of tackifier and approximately 25% by mass of cut fiber;
the cuts have lengths comprised between 1 mm and 15 mm, for example comprised between 3 mm and 6 mm.

According to a second aspect, the present application relates to a blade of a turbomachine, comprising a first outer skin and a second outer skin which are made of composite material connected to each other at an outer end of the blade, the first skin comprising a first inner end portion, the second skin comprising a second inner end portion, the first inner end portion and the second inner end portion being spaced apart from each other in such a way as to delimit therebetween an inner cavity of the blade that opens into an opening at an inner end of the blade, the inner end being radially opposite the outer end, the blade further comprising a reinforcement according to the first aspect, the reinforcement having dimensions corresponding substantially to dimensions of the inner cavity at the opening, the reinforcement being arranged in the inner cavity in such a way as to close the opening.

Optionally, the blade may further comprise a filling material arranged in the inner cavity radially between the reinforcement and the outer end of the blade.

According to a third aspect, the present application relates to an unducted turbomachine, comprising:
a casing;
a fan having a fan hub and peripheral fan vanes, integral with the fan hub, the fan hub having a downstream hub portion which is surrounded by an inner surface of an upstream portion of the casing and which projects beyond the upstream portion of the casing, the fan hub being rotatably mounted relative to the upstream portion of the casing about the longitudinal axis; and
at least one rectifier blade according to the second aspect, said blade being located downstream relative to the peripheral fan vanes, said blade being mounted on an outer surface of the upstream portion of the casing at an inner end of the blade, the reinforcement being arranged at the inner end of the blade.

According to a fourth aspect, the present application relates to a method for manufacturing a reinforcement according to the first aspect for a blade of a turbomachine, comprising the following steps:
E1: Cutting at least one fiber to obtain cuts having lengths greater than or equal to 1 mm;
E2: Preparing a tackifier by solubilizing an epoxy resin in a solvent;
E3: Mixing the cuts with the tackifier;
E4: Compacting the mixture; and
E5: Drying the compacted mixture so as to evaporate the solvent.

According to a fifth aspect, the present application relates to a method for manufacturing a blade of a turbomachine according to the second aspect, comprising the following steps: Producing a composite preform of the composite blade, said preform comprising a first outer skin and a second outer skin which are made of composite material connected to each other at an outer end of the blade, the first skin comprising a first inner end portion, the second skin comprising a second inner end portion, the first inner end portion and the second inner end portion being spaced apart from each other in such a way as to delimit therebetween an inner cavity of the blade that opens into an opening at an inner end of the blade, the inner end being radially opposite the outer end;
Producing a reinforcement by means of a method according to the fourth aspect, the reinforcement having dimensions substantially equal to dimensions of the inner cavity at the opening;
Placing the reinforcement in the inner cavity of the blade preform in such a way as to close the opening; and
Injecting resin into the assembly comprising the blade preform and the reinforcement.

### DESCRIPTION OF THE FIGURES

Other features, purposes and advantages will emerge from the following description, which is purely illustrative and not limiting, and which must be read in conjunction with the appended drawings in which:

FIG. 1 illustrates a schematic perspective sectional view of a blade according to the prior art.

FIG. 2 illustrates a schematic perspective view of a reinforcement according to one embodiment, the reinforcement having a second geometry different from the first geometry.

FIG. 3a illustrates a schematic radial cross-sectional view of a blade according to one embodiment.

FIG. 3b illustrates a schematic radial longitudinal sectional view of a blade according to one embodiment.

FIG. 4 illustrates a schematic sectional view of a punch-type tool adapted for implementing a method for manufacturing a reinforcement according to one embodiment.

FIG. 5 illustrates a partial schematic perspective view of a blade according to one embodiment.

FIG. 6 illustrates a schematic perspective view of an example of an unducted turbomachine comprising a blade according to one embodiment.

FIG. 7 is a block diagram illustrating a method for manufacturing a blade according to one embodiment.

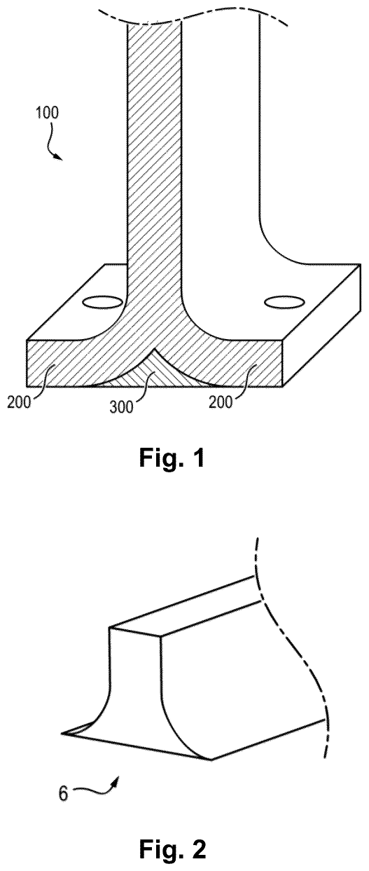

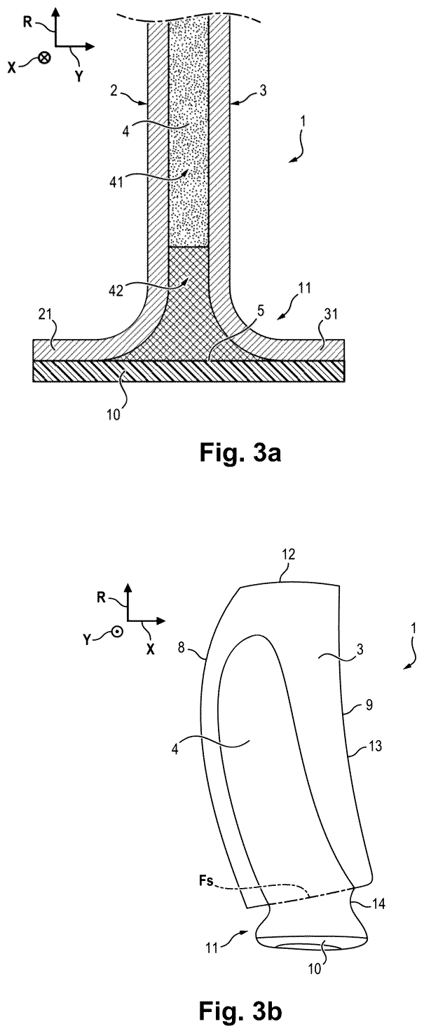

### DETAILED DESCRIPTION

### Turbomachine

In the present application, upstream and downstream are defined relative to the normal flow direction of the gas through the fan 200 of the turbomachine 100, an airflow flowing in the turbomachine 100 from upstream to downstream. The longitudinal axis X corresponds to an axis of rotation of the fan 200. A radial axis is an axis perpendicular to the longitudinal axis X and passing therethrough. A longitudinal, respectively radial direction corresponds to the direction of the longitudinal, respectively radial axis X. The terms inner and outer, respectively, are used with reference to a radial direction such that the inner portion or face of an element is closer to the longitudinal axis X than the outer portion or face of the same element. A width direction L of the blade 1 corresponds substantially to the longitudinal direction, a height direction R of the blade 1 corresponds to the radial direction at the blade 1, and a thickness direction Y of the blade 1 corresponds to the direction perpendicular to the width direction L and the height direction R of the blade 1.

The turbomachine 100 extends substantially around the longitudinal axis X. The turbomachine 100 comprises, from upstream to downstream in the direction of gas flow, at least one fan 200, or propeller, an engine assembly 300 comprising at least one compressor, a combustion chamber and at least one turbine, and a gas exhaust nozzle 108. For example, the engine assembly 300 of the turbomachine 100 may comprise a fan and a rectifier, a low-pressure compressor and a high-pressure compressor, the combustion chamber, and a high-pressure turbine and a low-pressure turbine. The high-pressure turbine rotates the high-pressure compressor via a high-pressure shaft extending along the longitudinal axis X. The low-pressure turbine rotates the low-pressure compressor via a low-pressure shaft extending along the longitudinal axis X. The low-pressure turbine can also rotate the fan 200 either directly via the low-pressure shaft or via a reduction gear arranged between the low-pressure turbine and the fan 200, the reduction gear being rotated by the low-pressure shaft.

Each compressor and each turbine may include one or more stages, each stage being formed by a set of fixed blades, or stator blading, and a set of rotating blades, or rotor blading. The fixed blades are fixed to a casing 101 of the turbomachine 100. The rotating blades of the low-pressure compressor and the low-pressure turbine are fixed to the low-pressure shaft. The rotating blades of the high-pressure compressor and the high-pressure turbine are fixed to the high-pressure shaft.

In operation, air flows through the rotating fan 200 and a first portion, called the primary flow, of the airflow is routed through the low-pressure compressor and the high-pressure compressor, the primary flow being compressed and then sent to the combustion chamber. The hot combustion products from the combustion chamber are used to drive the high-pressure turbine and the low-pressure turbine and thus produce the thrust of the turbomachine 100, and are discharged through the nozzle 108 located downstream of the engine assembly 300. A second portion of the air, called the secondary flow, is discharged from the rotating fan 200 around the casing 101 from upstream to downstream.

A blade 1 is a structural part of the turbomachine 100, intended to be integrated into a blading of the turbomachine 100. The blading comprises a hub which can be rotatably mounted relative to the casing 101 of the turbomachine 100 for a rotating blading, or be fixedly mounted relative to the casing 101 of the turbomachine 100 for a fixed blading. The blading further comprises a plurality of blades 1 fixed to the hub. The blades 1 extend substantially radially relative to the longitudinal axis X and can be distributed circumferentially around the longitudinal axis X.

The blading may have, for example, a diameter greater than or equal to 150 cm, preferably greater than or equal to 200 cm, for example less than or equal to 400 cm. Thus, the blade 1 has a sufficient span so that the blades 1 of the blading comprise two outer skins 2, 3 made of a composite material and delimiting an inner cavity 4. A blade 1 of the blading thus preferably has a height greater than or equal to 50 cm, preferably greater than or equal to 70 cm, for example of the order of 80 cm to 100 cm, being for example less than or equal to 160 cm.

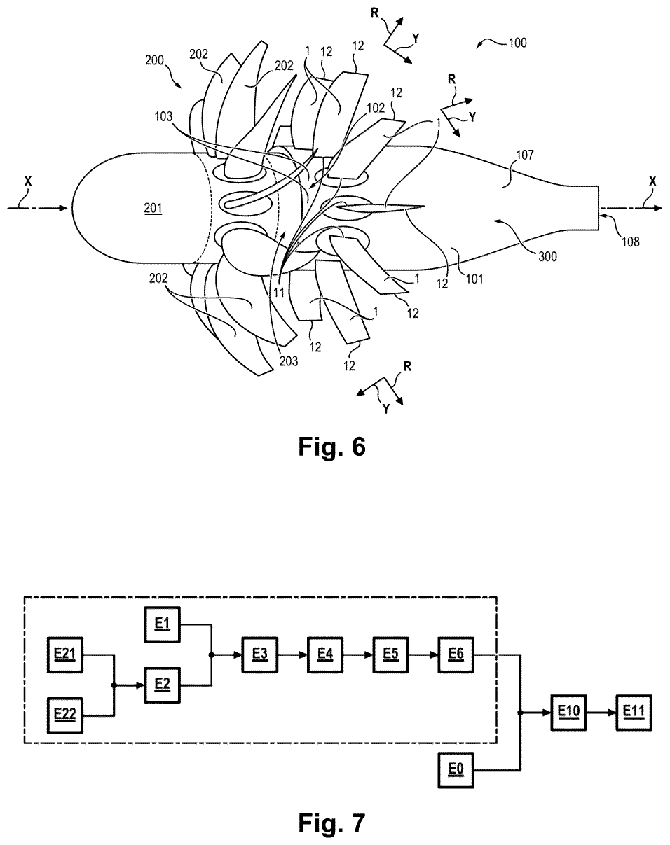

FIG. 6 illustrates a non-limiting example in which the turbomachine 100 is an unducted turbomachine whose rectifier comprises a blade 1 comprising a reinforcement 6 according to a particular embodiment. The turbomachine 100 comprises:
a casing 101;
a fan 200 having a hub 201 of the fan 200 and peripheral vanes 202 of the fan 200, integral with the hub 201 of the fan 200, the hub 201 of the fan 200 having a downstream portion 203 of the hub 201 which is surrounded by an inner surface 102 of an upstream portion 103 of the casing 101 and which protrudes from the upstream portion 103 of the casing 101, the hub 201 of the fan 200 being rotatably mounted relative to the upstream portion 103 of the casing 101 about the longitudinal axis X; and
at least one rectifier blade 1, said blade 1 being located downstream relative to the peripheral vanes 202 of the fan 200, said blade 1 being mounted on an outer surface of the upstream portion 103 of the casing 101 at an inner end of the blade 1, said blade 1 comprising a reinforcement 6 as described below, the reinforcement 6 being arranged at the inner end of the blade 1.

The casing 101 of the turbomachine 100 carries the fan 200 on its upstream side. The peripheral vanes 202 of the fan 200 are distributed on the hub 201 of the fan 200 around the longitudinal axis X of rotation upstream of the casing 101 of the turbomachine 100. The hub 201 of the fan 200 is able to rotate on itself relative to the upstream portion 103 of the casing 101 around the longitudinal axis X. The turbomachine 100 includes downstream of the hub 201 of the fan 200 and in the casing 101 a motor assembly 300 allowing to rotate the hub 201 of the fan 200 and therefore the peripheral vanes 202 of the fan 200 around the longitudinal axis X.

The rectifier blades 1 are located in the flow space of the secondary flow, which is created downstream of the peripheral vanes 202 of the fan 200 around the outer surface of the casing 101, when the peripheral vanes 202 of the fan 200 are rotated about the longitudinal axis X.

The turbomachine 100 being unducted, each secondary flow rectifier blade 1 is fixed or mounted in a movable manner on an outer surface of the upstream portion 103 of the casing 101, only at an inner end 11 of the blade. An outer end 12 of the blade 1, which is radially opposite relative to the inner end 11, is left bare in the secondary flow, without being mounted or fixed to a casing, no casing or nacelle surrounding the rectifier blades 1 and the casing 101.

The engine assembly 300 is located in the casing 101. An air inlet is located between the upstream portion 103 of the casing 101 and the hub 201 of the fan 200 and downstream of the peripheral vanes 202 of the fan 200. The rectifier blade 1 has a shape configured to concentrate the secondary flow against the outer surface of the downstream portion 107 of the casing 101, located downstream of the outer surface of the upstream portion 103 of the casing 101. An outer attachment arm or an outer attachment means connects the casing 101 to an aircraft.

It is understood that the reinforcement 6 may be a reinforcement 6 for a blade 1 of a turbomachine 100 of any type, for example of an unducted turbomachine 100, for example of a UDF type open rotor comprising two unducted and counter-rotating fans, or of a USF type open rotor comprising an unducted single fan and a rectifier. Alternatively, the reinforcement 6 may be a reinforcement 6 for a blade 1 of a ducted turbomachine 100, for example of a turbojet engine comprising a ducted fan 200.

Furthermore, it is understood that the reinforcement 6 may be a reinforcement 6 for any composite blade 1 of a turbomachine 100 requiring a thick reinforcement 6 or a geometry with progressive thickness, in particular for a partially hollow organic matrix composite blade 1 having a structural hollow area to be reinforced. Thus, the reinforcement 6 may be a reinforcement 6 for a composite blade 1 of any blading of a turbomachine 100, for example a reinforcement 6 for a fan 200, rectifier, compressor, and/or turbine blade 1.

### Blade

A blade 1 comprises an aerodynamically profiled vane 13 suitable for being placed in an airflow when the turbomachine 100 is operating in order to generate lift, and a root 14 configured to be fixed to the rotating or fixed hub of the blading comprising the blade 1 at the inner end 11 of the blade 1. The inner end 11 of the blade 1 thus corresponds to the mounting side of the blade 1.

The root 14 of the blade 1 may be fixed to the hub, which is fixed or rotating, of the blading, by a fastener receiving the root 14 of the blade 1 and fixing it to the hub of the blading. FIG. 5 illustrates by way of non-limiting example an example of a fastener comprising holes 210, 310 respectively passing through the first inner end portion 21 and the second inner end portion 31 in the radial direction R, and may comprise bolting or riveting in the holes, or the like.

The root 14 of the blade 1 corresponds to the portion of the blade 1 which is located under a line Fs delimiting the flow space of the secondary flow of the turbomachine 100, or secondary flow line Fs. Thus, the root 14 of the blade 1 is located in a radially inner position relative to a wall of the casing 101 of the turbomachine 100 which radially delimits the flow space of the secondary flow on the inside. In a ducted turbojet engine 100, the flow space of the secondary flow is a flow path of the secondary flow delimited on the inside by the wall of the casing 101, the casing 101 corresponding to an inner casing, and delimited on the outside by a wall of an outer casing of the turbojet engine 100. In an open rotor 100, the flow space of the secondary flow is a space external to the open rotor 10, which is delimited on the inside by the wall of the casing 101.

The wall of the casing 101 may be formed of one or a set of inter-blade platforms 1. The inter-blade platforms 1 may be formed integrally with the blades 1 or be separated and attached to the blades 1 of a blading at a junction between the root 14 of the blade 1 and the vane 13. The inter-blade platforms 1 delimit, on the inside, the flow space of the secondary flow at the blading.

The aerodynamically profiled vane 13 has a leading edge 8 and a trailing edge 9 connected by a pressure side wall and a suction side wall. The leading edge 8 of the vane 13 forms an upstream end of the vane 13 in the flow space. It corresponds to the front portion of an aerodynamic profile that faces the airflow and divides the airflow into a pressure side flow and a suction side flow. The leading edge 8 of the vane 13 is configured to extend opposite the flow of gases entering the turbomachine 100. The trailing edge 9 of the vane 13 corresponds to the rear portion of the aerodynamic profile, where the pressure side and suction flows meet, and forms a downstream end of the vane 13 in the flow space.

The blade 1 comprises a first outer skin 2 and a second outer skin 3 which are made of composite material, connected to each other at the outer end 12 of the blade 1. The first skin 2 and the second skin 3 extend generally opposite each other. The first skin 2 can form the pressure side wall of the vane 13 and the second skin 3 can form the suction side wall of the vane 13. The skins 2 and 3 form the outer surface of the blade 1, located in the secondary airflow during operation of the turbomachine 100. The first skin 2 and the second skin 3 carry the leading edge 8 and the trailing edge 9 of the blade 1.

The first skin 2 and the second skin 3 of the blade 1 are made of a composite material comprising a fibrous reinforcement densified by a matrix. The skins 2, 3 may be monolithic and be made in one piece from a fibrous preform with a changing thickness. Alternatively, the fibrous reinforcement may comprise a first skin 2 and a second skin 3, which are connected for example near the outer end 12 of the blade 1. The fibrous reinforcement comprises a vane portion intended to form the aerodynamically profiled vane 13, and a root portion intended to form the root 14 of the blade 1.

The fibrous reinforcement may comprise woven or knitted three-dimensional fibrous arrangements. It is further made such that it comprises strands (that is to say any type of thread(s)) that extend continuously both inside the vane 13 portion and inside the root 14 portion of the blade 1. Alternatively, the fibrous reinforcement may comprise laminated two-dimensional fibrous arrangements. The fibers of the fibrous reinforcement comprise at least one of the following materials: carbon (typically silicon carbide), glass, aramid, polypropylene and/or ceramic (typically an oxide ceramic). The matrix typically comprises an organic matrix (thermosetting, thermoplastic or elastomeric) or a carbon matrix. For example, the matrix comprises a plastic material, typically a polymer, for example epoxy, bismaleimide or polyimide.

The first skin 2 comprises a first inner end portion 21 and the second skin 3 comprises a second inner end portion 31. The first inner end portion 21 and the second inner end portion 31 are spaced apart from each other in such a way as to delimit therebetween an inner cavity 4 of the blade 1 that opens into an opening 5 at an inner end 11 of the blade 1, the inner end 11 being radially opposite the outer end 12.

The inner end 11 of the blade 1 corresponds to a mounting end of the first skin 2 and the second skin 3 on a rotating or fixed hub of the blading comprising the blade 1. The blade 1 may be fixed to the rotating or fixed hub of the blading at its only inner end 11, in particular in the case of an unducted turbomachine 100, or at both its inner end 11 and its outer end 12, in particular in the case of a ducted turbomachine 100.

A height of the blade 1 corresponds to a distance along the radial axis between the inner end 11 and the outer end 12 of the blade 1. The outer end 12 of the blade 1 corresponds to a tip of the blade 1. A height of the vane 13 corresponds to a distance along the radial axis between an inner end and an outer end of the vane 13. A height of the root 14 corresponds to a distance along the radial axis between an inner end and an outer end of the root 14. The outer end 12 of the blade 1 corresponds to the outer end of the vane 13, and the inner end 11 of the blade 1 corresponds to the inner end of the root 14. The inner end of the vane 13 may correspond to the outer end of the root 14.

The skins 2, 3 of the fiber reinforcement are separated by the inner cavity 4 which is open at the inner end of the blade 1, which allows to further reduce the mass of the blade 1 in comparison with a conventional blade 1. In the case where the skins 2, 3 are obtained by three-dimensional weaving and are monolithic, the inner cavity 4 is obtained by creating a disconnection in the fiber reinforcement between two successive warp layers, from a so-called non-disconnected area (here comprising the head 12 of the blade 1) to the inner end 11 of the skins 2, 3, where the inner cavity 4 opens at the opening 5. For this purpose, at the disconnection, the warp strands of two successive layers of the fiber blank are not connected by weft strands. Preferably, the disconnection extends within the aerodynamically profiled vane 13 and extends to the inner end of the root 14 of the blade 1.

In the vane portion of the fiber reinforcement, the inner cavity 4 is not open on the leading edge 8 or the trailing edge 9. The portions of the fiber reinforcement forming the leading edge 8 and the trailing edge 9 are therefore not disconnected. The leading edge 8 and/or the trailing edge 9 may be attached and fixed to the fiber reinforcement, as described below concerning the method for manufacturing the blade 1. On the other hand, in the root portion of the fiber reinforcement, the inner cavity 4 may be open on the upstream and downstream edges of the root 14 of the blade 1, which extend in the extension of the leading edge 8 and the trailing edge 9 of the vane 13, respectively. The portions of the fiber blank forming the upstream edge and the downstream edge of the root 14 of the blade 1 may therefore be disconnected.

Reference may be made, for example, to document EP2588758 in the name of the Applicant for more details on the production of disconnections.

The first inner end portion 21 and the second inner end portion 31 correspond to the portions of the skins 2, 3, which are located in a radially inner position relative to the disconnection made in the fiber reinforcement. The first inner end portion 21 and the second inner end portion 31 may extend over the entire height of the root 14 of the blade 1 and over at least a portion of the height of the vane 13 of the blade 1, or even over substantially the entire height of the vane 13 of the blade 1 when the disconnection is located substantially at the outer end 12 of the blade 1. Thus, the first inner end portion 21 and the second inner end portion 31 are adapted to together define outer walls of the root 14 and of at least a portion of the vane 13 of the blade 1, such that the inner cavity 4 comprises a root portion and a vane portion. The inner cavity 4 thus extends over the entire height of the root 14 of the blade 1, and over at least a portion of the height of the vane 13, or even over substantially the entire height of the vane 13.

The first skin 2 and the second skin 3 can move away 101 from each other towards the inner end 11 of the blade 1 along the thickness direction Y of the blade 1. The inner cavity 4 is located in a radially outer position relative to the opening 5 and thus has a maximum thickness at the opening 5, that is to say at the inner end 11 of the blade 1.

A plate 10 may be fixed under and against the first inner end portion 21 and the second inner end portion 31 and be located under and against the opening 5 and the reinforcement 6. The plate 10 allows to make a connection between the first inner end portion 21 and the second inner end portion 31.

The blade 1 may be a variable-pitch rectifier blade. The rectifier comprises a hub fixedly mounted relative to the casing 101 of the turbomachine 100, and is therefore non-rotating. The stator blades 1 extend substantially radially relative to the longitudinal axis X. The blade 1 then comprises an actuating mechanism for modifying the pitch angle of the blade in order to adapt the performance of the turbomachine 100 to the different flight phases. In addition, each blade 1 comprises a fastener, or pivot, arranged at the root 14 of the blade 1. The fastener is rotatably mounted relative to the hub around the pitch axis. More precisely, the fastener is rotatably mounted inside a housing provided in the hub, by means of balls or other rolling elements. Thus, each root 14 of the rectifier blade 1 is pivotally mounted along a pitch axis and connected to a pitch change system mounted in the turbomachine 100.

### Reinforcement

A reinforcement 6 (or “Spar filler”), illustrated as a non-limiting example in FIG. 2, is a sub-component of the blade 1. The reinforcement 6 is adapted to be arranged in the inner cavity 4 in such a way as to close the opening 5. Furthermore, the reinforcement 6 helps to form and/or compact the three-dimensionally woven skins.

The reinforcement 6 comprises a mixture of cuts of at least one fiber and a tackifier. The cuts may have lengths greater than or equal to 1 mm. The tackifier may comprise an epoxy resin solubilized in a solvent.

The reinforcement 6 described above allows to fill the opening 5 between the first inner end portion 21 and the second inner end portion 31, to correctly form the 3D woven skins and to provide improved mechanical strength once the part has polymerized, in particular bending stiffness, at the inner end 11 of the blade 1 which is an area where the stresses are greatest. The reinforcement 6 therefore allows a satisfactory compromise between stiffness and mass to improve the mechanical strength of the blade 1, for example compared to the addition of a spar or compared to an increase in the thickness of the composite outer skins 2, 3. The stiffening of the area located at the inner end 11 of the blade 1 allows to reduce the stresses in the composite outer skins 2, 3 compared to a solution whose cavity would be filled only with foam or provided with an insert as described in document FR 3 063 514 A1. The increase in stiffness also allows to limit the movement of the outer end 12 of the blade 1.

The mixture of fiber cuts and tackifier allows to create a reinforcement 6 having a significant volume and a profile, that is to say a complex geometry with large variations in dimensions, in particular large variations in thickness over a reduced height. The reinforcement 6 can thus close the inner cavity 4 of the blade 1, in particular at an inner end 11 of the blade 1 located at the area of attachment of the blade 1 to a casing 101 of the turbomachine 100.

Furthermore, the mixture of fiber cuts and tackifier allows to obtain a reinforcement which has sufficient cohesion to ensure its role as structural reinforcement of the blade 1. The use of simple fiber cuts alone would not allow such cohesion.

Furthermore, the mixture of fiber cuts and tackifier is simple and quick to manufacture.

Finally, the use of such a mixture, in particular containing short fibers of lengths greater than or equal to 1 mm, allows to control exactly the composition of the reinforcement 6 obtained, for example the amount of fibers and the volume ratio of fibers.

The reinforcement 6 may have a rigidity greater than 15 (+/−5) GPa in the radial direction R of the blade 1. Thus, the reinforcement 6 contributes to the overall stiffness of the blade 1, to limit the risk of buckling and improve the frequency placement of the blading comprising the blade 1.

The volumetric rate of fibers of the reinforcement 6 is preferably comprised between 20% and 50%, for example between 30% and 45%, so as to ensure optimal mechanical properties of the reinforcement 6.

The reinforcement 6 may have dimensions corresponding substantially to dimensions of the inner cavity 4 of the blade 1 at the opening 5. Thus, the reinforcement 6 is arranged in the inner cavity 4 in such a way as to close the opening 5. The reinforcement 6 may have dimensions corresponding substantially to dimensions of the inner cavity 4 over an entire height of the reinforcement 6, the reinforcement 6 being arranged in a portion of the inner cavity 4 so as to at least partially fill said inner cavity 4. More particularly, the reinforcement 6 may comprise a root portion arranged in the root portion of the inner cavity 4 and a vane portion arranged in the vane portion of the inner cavity 4. The root portion of the reinforcement 6 may have dimensions corresponding substantially to the dimensions of the root portion of the inner cavity 4 so that the root portion of the reinforcement 6 completely closes the root portion of the inner cavity 4. The vane portion of the reinforcement 6 may have dimensions corresponding substantially to the dimensions of a portion of the vane portion of the inner cavity 4 so that the vane portion of the reinforcement 6 partially closes the vane portion of the inner cavity 4.

The reinforcement 6 may have a downwardly flared shape, that is to say an inverted funnel shape. Thus, a shape of the reinforcement 6 corresponds substantially to a shape of the inner cavity 4 of the blade 1 at the end portions of the blade 1 which diverge from each other in the thickness direction Y of the blade 1.

Hereinafter, reference is made to a cut fiber. It is understood that the cuts may be made in a single fiber or in several fibers, the several fibers being cut to obtain the cuts.

The fiber may be a carbon fiber such as an IM7 fiber or a T1100 fiber. Alternatively, the fiber may be a glass fiber. The fiber may be an oversized fiber.

The cuts may have lengths comprised between 1 mm and 15 mm, for example comprised between 3 mm and 6 mm. Thus, the cuts are even shorter, the fiber from which the cuts are obtained can be shorter, and the composition of the reinforcement 6 can be controlled with better repeatability.

The cut fiber may be a strip of prepreg comprising fibers, for example carbon fibers.

The cut fiber may be a recycled fiber. The use of a recycled and cut fiber for a reinforcement-type subcomponent 6 of a structural part of the blade 1 type of a turbomachine allows to reduce the cost of the reinforcement 6, and to quickly manufacture a reinforcement 6 of complex shape. The recycled fiber may for example be a fiber from the end of a reel, for example from an end of a reel not used at the end of a weaving campaign, or from a waste of the woven preform of the blade 1, for example from a surface wire cutting (“trimming”) of the woven preform of the blade 1, etc.

Alternatively, the cut fiber may be a new fiber. The use of a new fiber may allow the mechanical properties of the reinforcement 6 to be adapted and improved according to the desired properties.

The tackifier may comprise between 20% and 85% by mass of epoxy resin and between 15% and 80% by mass of solvent, preferably approximately 25% by mass of epoxy resin and approximately 75% by mass of solvent. Such mass proportions of approximately 25% epoxy resin and approximately 75% solvent allow to obtain a tackifier having optimum properties for producing the reinforcement 6. When the proportion of epoxy resin is increased to approximately 85%, the cohesion of the mixture of tackifier and fiber cuts is still ensured.

The epoxy resin can be, for example, PR520, DGEBA or DGEBF resin. The PR520 resin has good tackifying properties. Epoxy resin, in particular PR520 resin, is solubilized in a solvent to obtain the tackifier. Indeed, at room temperature, PR520 resin has a high viscosity, which makes mixing the non-solubilized PR520 resin with the fiber cuts difficult or even impossible. Furthermore, it is not necessary to provide a large amount of epoxy resin to the fiber cuts to ensure the cohesion of the mixture. Therefore, solubilizing the epoxy resin in a solvent does not harm the cohesion of the reinforcement 6.

The solvent may be acetone, or any other solvent compatible with the epoxy resin used, that is to say allowing the epoxy resin to be dissolved. The mixture of PR520 resin and acetone allows to obtain a tackifier having satisfactory properties. In particular, the tackifier may comprise approximately 25% by mass of PR520 resin and approximately 75% by mass of acetone, in order to obtain a tackifier having optimum properties for producing the reinforcement 6.

The mixture may comprise between 65% and 85% by mass of tackifier and between 15% and 35% by mass of cut fiber, preferably about 75% by mass of tackifier and about 25% by mass of cut fiber. A ratio of about 75% by mass of tackifier and about 25% by mass of cut fiber allows to obtain an ideal mixture texture for the manufacture of the reinforcement 6.

The reinforcement 6 is radially delimited by an inner edge and an outer edge opposite the inner edge. A distance, for example an average distance, between the inner edge and the outer edge of the reinforcement 6, corresponds to a height of the reinforcement 6. The inner edge of the reinforcement 6 can be arranged at the opening 5. The reinforcement 6 can extend between the inner edge and the outer edge over at least a portion of the height of the root 14 of the blade 1 and where appropriate over at least a portion of the height of the blade 1.

The height of the reinforcement 6 may be greater than 3% of the height of the blade 1, for example greater than 5% of the height of the blade 1, for example greater than 10% of the height of the blade 1. The height of the reinforcement 6 may be less than 50% of the height of the blade 1, for example less than 25% of the height of the blade 1, for example less than 15% of the height of the blade 1, for example less than 10% of the height of the blade 1. By way of non-limiting example, the height of the reinforcement 6 may be comprised between 5% and 15% of the height of the blade 1.

In a first embodiment, the reinforcement 6 extends below, that is to say in a position radially more internal than, the secondary flow line Fs delimiting the flow space of the secondary flow of the turbomachine 100. Thus, the reinforcement 6 extends in only a portion of the root 14 of the blade 1. The stiffness of the blade 1 is therefore increased at the root 14 of the blade 1 and the mass impact due to the presence of the reinforcement 6 on the blade 1 is limited. For example, the height of the reinforcement 6 may be less than 50 mm. The height of the reinforcement 6 may be less than approximately 10% of the height of the blade 1, or even less than approximately 5% of the height of the blade 1, or even less than approximately 3% of the height of the blade 1.

In a second embodiment, the reinforcement 6 extends in a portion of the root 14 of the blade 1 and in a portion of the vane 13. An upstream end of the outer edge of the reinforcement 6, that is to say an end of the reinforcement located on the leading edge 8 side of the blade 1, extends above, that is to say in a position radially more external than, the secondary flow line Fs at the leading edge 8 of the blade 1. A downstream end of the outer edge of the reinforcement 6, that is to say an end of the reinforcement located on the trailing edge 9 side of the blade 1, extends below, that is to say in a position radially more internal than, the secondary flow line Fs at the trailing edge 9 of the blade 1. Thus, the stiffness of the blade 1 is increased at the root 14 of the blade 1 and at the leading edge 8 of the blade 1, where a large portion of the stresses are located, while limiting the mass impact on the blade 1 comprising the reinforcement 6. For example, the height of the reinforcement 6 can be comprised between 50 mm and 100 mm. The height of the reinforcement 6 can be comprised between approximately 3% and approximately 20% of the height of the blade 1, for example be comprised between approximately 10% and approximately 15% of the height of the blade 1.

In a third embodiment, the reinforcement 6 extends in the root 14 of the blade 1 and in at least a portion of the vane 13 of the blade 1, an outer edge of the reinforcement 6 extending radially above, that is to say in a position radially more external than, the secondary flow line Fs. Thus, the reinforcement 6 extends in the root 14 of the blade 1 over the entire height of the root 14 of the blade 1, and further extends in the vane 13 of the blade 1, over at least a portion of the height of the vane 13, or even over substantially the entire height of the vane 13. Thus, the stiffness of the blade 1 is further increased, both at the root 14 of the blade 1 and at the leading edge 8 and the trailing edge 9 of the vane 13. For example, the height of the reinforcement 6 may be greater than 100 mm. The height of the reinforcement 6 may be greater than approximately 5% of the height of the blade 1, or even greater than approximately 10% of the height of the blade 1, or even greater than approximately 20% of the height of the blade 1, or even greater than approximately 50% of the height of the blade 1.

### Filling Material

The blade 1 may further comprise a filling material 41 arranged in the inner cavity 4 radially between the reinforcement 6 and the outer end 12 of the blade 1. The filling material 41 thus extends radially above the reinforcement 6, that is to say in a position radially more external than the reinforcement 6, at a distance from the opening 5. The filling material 41 may be arranged against the reinforcement 6, that is to say in contact with the outer edge of the reinforcement 6.

The filling material 41 may have a density lower than a density of the reinforcement 6 and/or lower than a density of the composite material of the outer skins 2, 3, the filling material 41 being inserted into a hollow area of the blade 1 which is not a structural area and therefore does not need to be reinforced. The filling material 41 may have, for example, a density of the order of a hundred kg/m³ and a stiffness of the order of a hundred MPa. The filling material 41 may be integrated into one or more filling parts, each filling part being adapted to be arranged in the inner cavity 4 of the blade 1.

The filling material 41 may for example be a foam, such as a foam of organic (polyethacrylimide, polyethylene terephthalate (PET), polyvinyl chloride (PVC), polyetherimide (PEI), polyvinyl, carbon, polyisocyanurate, polyurethane, etc.) or metallic origin (in particular aluminum alloy), or else a honeycomb of the Nomex® type (comprising aramid fibers calendered into sheets and covered with phenolic resin), Kevlar, glass fibers or else aluminum.

The filler material 41 may be arranged only in the vane portion of the inner cavity 4, in particular when the reinforcement 6 extends throughout the root portion of the inner cavity 4 and in a portion of the vane portion of the inner cavity 4. The filler material 41 may extend in only a portion of the vane portion of the inner cavity 4, or in only the entire vane portion of the inner cavity 4, in particular when the reinforcement 6 extends in only a portion of the root portion of the inner cavity 4. The filler material 41 allows to stiffen the outer skins 2, 3 and/or to give the outer skins 2, 3 the final shape of the vane 13, with minimal impact on the mass of the blade 1.

### Method for Manufacturing the Reinforcement

A method for manufacturing a reinforcement 6 as described above for a blade 1 of a turbomachine 100 as described above comprises the following steps:
E1: Cutting at least one fiber to obtain cuts having lengths greater than or equal to 1 mm;
E2: Preparing a tackifier by solubilization of an epoxy resin in a solvent;
E3: Mixing the cuts with the tackifier;
E4: Compacting the mixture; and
E5: Drying the compacted mixture so as to evaporate the solvent.

The method described below generally has the same advantages as those described concerning the reinforcement 6 described above. In particular, the method allows to quickly create a reinforcement 6 having a complex geometry.

Furthermore, the method is particularly simple to carry out, in that it does not require a cutting step or the use of an autoclave.

The features of fiber properties, tackifier composition, composition of the mixture of the cuts and the tackifier, etc., described above with respect to the reinforcement 6, can independently be used in the steps of the method described above. In particular, the fiber cut in step E1 can be a carbon or glass fiber, and can be a recycled fiber or a new fiber. The cuts obtained at the end of step E1 can have lengths comprised between 1 mm and 15 mm, for example comprised between 3 mm and 6 mm. The epoxy resin used in step E2 to prepare the tackifier can be a PR520 resin. The solvent used in step E2 to prepare the tackifier can be acetone. The tackifier prepared in step E2 may comprise between 20% and 85% by mass of epoxy resin and between 15% and 80% by mass of solvent, preferably about 25% by mass of epoxy resin and about 75% by mass of solvent. The mixture of the cuts with the tackifier prepared in step E3 may comprise between 65% and 85% by mass of tackifier and between 15% and 35% by mass of cut fiber, preferably about 75% by mass of tackifier and about 25% by mass of cut fiber.

Step E1 may comprise cutting one or more fibers, so as to obtain the fiber cuts. Step E1 may correspond to a simultaneous cutting of several fibers.

Step E2 of preparing the tackifier may comprise, as illustrated by way of non-limiting example in FIG. 7, a sub-step E21 of providing the epoxy resin and a sub-step E22 of providing the solvent.

Step E3 of mixing the cuts and the tackifier may consist of mixing the cut fibers and the solvent in the mass proportions described above. Mixing the cuts and the tackifier in step E3 allows the tackifier to be incorporated into the fiber cuts.

In a first exemplary embodiment of step E3, the fiber cuts are placed in a container. The tackifier is poured into the container, before mixing or gradually during mixing. The set of cuts and tackifier is mixed in the container until the tackifier is completely absorbed by the fiber cuts. For small volumes, it is possible to mix manually. For an industrial application, it is possible to use mixing robots in order to freeze the key parameters such as the mixing tools, the rotation speed, the mixing time, etc., and thus improve the repeatability of the mixture. In a second exemplary embodiment of step E3, the tackifier is sprayed onto the fiber cuts.

In order to carry out the compacting step E4, the mixture of fiber cuts and tackifier is deposited in a cavity 410 of a shaping and/or compacting and/or drying tool 400. The tool 400 may comprise a mold forming the cavity 410. The pasty and viscous nature of the mixture of fiber cuts and tackifier allows to distribute the fiber homogeneously in the cavity 410 of the tool 400, including for a cavity 410 having a complex geometry. In particular, the cavity 410 of the mold of the tool 400 may have a counterform relative to the reinforcement 6 to be created, dimensions of the counterform corresponding substantially to dimensions of the portion of the inner cavity 4 of the blade 1 in which the reinforcement 6 is intended to be arranged. The mixture of fiber cuts and tackifier is deposited in the cavity 410 so as to fill the cavity 410 in order to create the reinforcement 6 having the desired geometry. The tool 400 can then be closed in preparation for the compacting step E4.

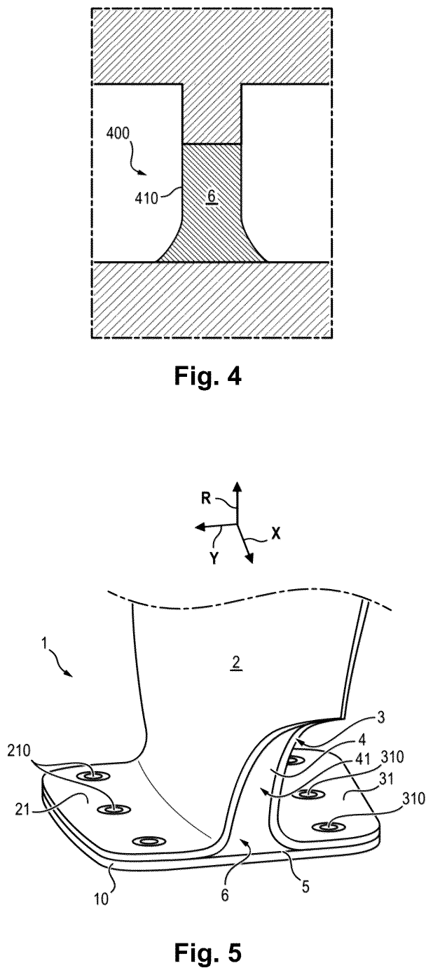

The compacting step E4 allows to compact the mixture of fiber cuts and tackifier placed in the cavity 410 to obtain the desired final dimensions of the reinforcement 6 and ensure the cohesion of the mixture. The tool 400 may be of the box type, the box comprising different inserts to be closed to ensure compaction. Alternatively, the tool 400 may be of the die or punch type, as illustrated by way of non-limiting example in FIG. 4. The punch then compacts the fiber homogeneously. The mold forming the cavity 410 may be tightened, for example under pressure.

The compacted mixture is then soaked in solvent. The drying step E5 accelerates the evaporation of the solvent, to obtain a hardened part. The drying step E5 may comprise an oven drying cycle. The drying step E5 may be carried out in the tool 400. For a reinforcement 6 having a fiber volume ratio of approximately 40% and a cavity of approximately 95 cubic centimeters, the drying step E5 may be carried out for a period of approximately 3 hours and at a temperature of approximately 120° C. The drying cycle of step E5 can be adapted according to the nature of the fiber cuts, the composition of the tackifier, and the mass proportions of the mixture of fiber cuts and tackifier, used to produce the reinforcement 6. The method may further comprise a step E6 of demolding the mixture compacted during step E4 and dried during step E5, in order to remove the compacted and dried mixture from the tool 400. The tool 400 having previously been covered with Teflon, the demolding of the mixture compacted and dried during step E6 is possible by removing the shims one by one.

The compacted and dried mixture comprises interstices that a resin can fill during a co-injection carried out in step E11 described below. Depending on the resin used, the compacted and dried mixture can be partially polymerized, which allows to increase its rigidity, or may not be polymerized. In the case of the use during step E2 of a PR520 resin to prepare the tackifier, the compacted and dried mixture obtained is partially polymerized, in particular is sufficiently rigid to be handled and draped as a sub-component of the blade 1. Furthermore, the partial polymerization of the compacted and dried mixture allows to obtain a good interface during the co-injection of the reinforcement 6 with the rest of the elements of the blade 1 during step E11. In the case of using in step E2 an epoxy resin without hardener to prepare the tackifier, the compacted and dried mixture obtained is not polymerized, and is therefore less rigid, but is nevertheless sufficiently rigid to be able to be used as a sub-component of the blade 1.

### Method for Manufacturing the Blade

A blade 1 as described above can be obtained using the manufacturing method which follows, and which is illustrated as a non-limiting example in FIG. 7. This is not, however, limiting, other methods being able to be considered for the production of such a blade 1. The method for manufacturing the blade 1 can comprise the following steps:
Producing a composite preform of the composite blade 1 during a step E0, said preform comprising a first outer skin 2 and a second outer skin 3 which are made of composite material connected to each other at an outer end 12 of the blade 1, the first skin 2 comprising a first inner end portion 21, the second skin 3 comprising a second inner end portion 31, the first inner end portion 21 and the second inner end portion 31 being spaced apart from each other in such a way as to delimit therebetween an inner cavity 4 of the blade 1 that opens into an opening 5 at an inner end 11 of the blade 1, the inner end 11 being radially opposite the outer end 12;
Manufacturing a reinforcement 6 by means of a method for manufacturing a reinforcement 6 as described above, the reinforcement 6 having dimensions substantially the same as the dimensions of the inner cavity 4 at the opening 5;
Placing the reinforcement 6 in the inner cavity 4 of the blade preform 1 in such a way as to close the opening 5; and
Injecting resin into the assembly comprising the blade preform 1 and the reinforcement 6 during a step E11.

This method allows the reinforcement 6 to be injected at the same time as the rest of the blade 1. Thus, the reinforcement 6 is bonded to the skins 2, 3 of the blade 1 without the use of glue or surface treatment. Furthermore, the reinforcement 6 ensures good compaction of the skins 2, 3 of the blade 1 in the radii during shaping, ensuring the desired fiber volume ratio in the radii.

The fiber preform of the blade 1 can be produced during step E0 for example by three-dimensional weaving or knitting. In an exemplary embodiment, the fiber blank is woven in three dimensions with the production of a disconnection in order to obtain the two skins 2, 3 and the inner cavity 4, as described above concerning the blade 1. The two skins 2, 3 are monolithic at the head 12 of the blade 1, the leading edge 8 and the trailing edge 9 of the vane 13. The inner cavity 4 is open at the root 14 of the blade 1 and extends into the vane 13.

The manufacture of the preform of the blade 1 may comprise a step of cutting surface threads of the woven preform (“Trimming”), in particular when threads of the preform remain non-woven and protrude.

A filling material 41 may be placed in the inner cavity 4, following the placement of the reinforcement 6 in the inner cavity 4 or prior to this placement.

During step E10, the reinforcement 6 can be placed in the inner cavity 4, for example, pressing against the filling material 41. The reinforcement 6 closes the inner cavity 4 of the blade 1 at the opening 5.

The assembly formed by the fibrous preform, the filling material 41 and the reinforcement 6 can then be placed in an injection mold. The injection mold can have a counterform of dimensions corresponding substantially to the dimensions of the final molded blade 1, namely the desired vane 13 and root 14 of the blade 1. The mold is then closed, for example by a wall which closes the opening 5, in order to carry out the injection.

The resin injected during step E11, which forms the “matrix” of the composite material, is a generally plastic material. The resin is injected into the injection mold so as to impregnate the fibrous reinforcement of the skins 2, 3, the filling material 41 and the reinforcement 6.

The injection of the matrix can be carried out by an injection technique of the RTM or VARRTM type. In the case of a plastic material, the injected matrix is for example a thermosetting liquid composition containing an organic precursor of the matrix material. The organic precursor is usually in the form of a polymer, such as a resin, possibly diluted in a solvent. In a manner known per se, the plastic material is then heated so as to cause its polymerization, for example by crosslinking. For this purpose, the injection mold is placed in an oven. The part obtained can then be demolded from the injection mold.

Optionally, a leading edge 8 can be inserted into the upstream portion of the preform of the blade 1. An outer layer forming the leading edge 8 is then placed on the preform to achieve the pairing of the leading edge 8. Then, the leading edge 8 is passed through the autoclave to be bonded to the preform.

Then, one or more steps of various finishing and/or completions can be carried out. For example, the demolded part can be cut by machining to remove excess lengths and obtain a part having the desired shape, despite possible shrinkage of the fibers of the fibrous reinforcement during polymerization of the plastic material. The sacrificial thicknesses are in particular machined to obtain the reference surfaces of the root 14 of the blade 1. Through passages are also machined in the skins 2, 3 to receive the fixing system. Where appropriate, counterbores are also machined around the through passages.

1.-10. (canceled)

11. A reinforcement for a blade of a turbomachine, the blade comprising a first outer skin and a second outer skin which are made of composite material connected to each other at an outer end of the blade, the first skin comprising a first inner end portion, the second skin comprising a second inner end portion, the first inner end portion and the second inner end portion being spaced apart from each other in such a way as to delimit therebetween an inner cavity of the blade that opens into an opening at an inner end of the blade, the inner end being radially opposite the outer end, wherein the reinforcement is adapted to be arranged in the inner cavity in such a way as to close the opening, and wherein the reinforcement comprises a mixture of cuts of at least one fiber and a tackifier, the cuts having lengths comprised between 1 mm and 15 mm, the tackifier comprising an epoxy resin solubilized in a solvent.

12. The reinforcement according to claim 11, wherein the cuts are obtained from a strip of prepreg comprising carbon fibers,

13. The reinforcement according to claim 11, wherein the strip of prepreg is recycled.

14. The reinforcement according to claim 11, wherein which the tackifier comprises between 20% and 85% by mass of epoxy resin, wherein the epoxy resin is preferably PR520 resin and the solvent is preferably acetone.

15. The reinforcement according to claim 14, wherein which the tackifier comprises approximately 25% by mass of epoxy resin.

16. The reinforcement according to claim 11, wherein the mixture comprises between 65% and 85% by mass of tackifier and between 15% and 35% by mass of cut fiber.

17. The reinforcement according to claim 11, wherein the mixtures comprises approximately 75% by mass of tackifier and approximately 25% by mass of cut fiber.

18. The reinforcement according to claim 11, wherein the cuts have lengths comprised between 3 mm and 6 mm.

19. A blade of a turbomachine, comprising a first outer skin and a second outer skin which are made of composite material connected to each other at an outer end of the blade, the first skin comprising a first inner end portion, the second skin comprising a second inner end portion, the first inner end portion and the second inner end portion being spaced apart from each other in such a way as to delimit therebetween an inner cavity of the blade that opens into an opening at an inner end of the blade, the inner end being radially opposite the outer end, the blade further comprising a reinforcement according to claim 11, wherein the reinforcement has dimensions corresponding substantially to dimensions of the inner cavity at the opening, the reinforcement being arranged in the inner cavity in such a way as to close the opening.

20. The blade according to claim 19, further comprising a filler material arranged in the inner cavity radially between the reinforcement and the outer end of the blade.

21. An unducted turbomachine, comprising:
a casing;
a fan having a fan hub and peripheral fan vanes, integral with the fan hub, the fan hub having a downstream hub portion which is surrounded by an inner surface of an upstream portion of the casing and which protrudes from the upstream portion of the casing, the fan hub being rotatably mounted relative to the upstream portion of the casing about the longitudinal axis (X); and
at least one blade according to claim 16, the blade being a rectifier blade and being located downstream relative to the peripheral vanes of the fan, the rectifier blade being mounted on an outer surface of the upstream portion of the casing at an inner end of the rectifier blade, the reinforcement being arranged at the inner end of the rectifier blade.

22. A method for manufacturing a reinforcement according to claim 11 for a blade of a turbomachine, comprising the following steps:
E1: Cutting at least one fiber to obtain cuts having lengths greater than or equal to 1 mm;
E2: Preparing a tackifier by solubilizing an epoxy resin in a solvent;
E3: Mixing the cuts with the tackifier;
E4: Compacting the mixture; and
E5: Drying the compacted mixture so as to evaporate the solvent.

23. A method for manufacturing a blade of a turbomachine according to claim 19, comprising the following steps:
producing (E0) a composite preform of the composite blade, said the composite preform comprising a first outer skin and a second outer skin which are made of composite material connected to each other at an outer end of the blade, the first skin comprising a first inner end portion, the second skin comprising a second inner end portion, the first inner end portion and the second inner end portion being spaced apart from each other in such a way as to delimit therebetween an inner cavity of the blade that opens into an opening at an inner end of the blade, the inner end being radially opposite the outer end;
manufacturing a reinforcement by means of a method according claim 22, the reinforcement having dimensions substantially the same as the dimensions of the inner cavity at the opening;
placing the reinforcement in the inner cavity of the blade preform in such a way as to close the opening; and
injecting resin into the assembly comprising the blade preform and the reinforcement (E11).
